(19) United States
(12) Patent Application Publication
(10) Pub. No.: US 2025/0084285 A1
(43) Pub. Date: Mar. 13, 2025

(54) THERMO-SWITCHABLE PRESSURE-SENSITIVE ADHESIVES

(71) Applicant: Northeastern University, Boston, MA (US)

(72) Inventors: Ruobing Bai, Natick, MA (US); Qianfeng Yin, Boston, MA (US); Yichen Wan, Malden, MA (US)

(21) Appl. No.: 18/830,163

(22) Filed: Sep. 10, 2024

Related U.S. Application Data
(60) Provisional application No. 63/617,185, filed on Jan. 3, 2024.
(60) Provisional application No. 63/537,617, filed on Sep. 11, 2023.

(51) Int. Cl. C09J 7/38; C09J 5/06; C09J 11/04

(52) U.S. Cl. CPC C09J 7/385; C09J 5/06; C09J 11/04

(57) ABSTRACT

Disclosed are adhesive materials comprising a polymer and a filler; wherein a) if the temperature of the adhesive material is equal to or below a reference temperature, then the adhesive material adheres to an adherend; and b) if the temperature of the adhesive material is above the reference temperature, then the adhesive does not adhere to an adherend. Further disclosed are methods of making the adhesive materials.

### RELATED APPLICATIONS

This application claims the benefit of priority to U.S. Provisional Patent Application Nos. 63/537,617, filed Sep. 11, 2023; and 63/617,185, filed Jan. 3, 2024.

### BACKGROUND

Adhesions that can swiftly switch between strong and weak many times on various substrates are vital for living creatures from geckos to insects. However, switchable adhesion is hard to achieve in artificial materials since strong adhesion is usually accompanied by difficult detachment. This challenge hinders the advancement of many emerging applications such as high-performance robots, advanced manufacturing, and reversible, easy-detaching adhesives. Therefore, better switchable adhesives are needed.

### SUMMARY

In some embodiments, the present disclosure relates to an adhesive material, comprising a polymer and a filler; wherein the adhesive material has a temperature; and
a) if the temperature of the adhesive material is equal to or below a reference temperature, then the adhesive material adheres to an adherend; and
b) if the temperature of the adhesive material is above the reference temperature, then the adhesive does not adhere to an adherend.

In some embodiments, the present disclosure relates to a method of making the adhesive material of the disclosure, comprising
a) combining the polymer, the filler, and a solvent, thereby producing a first solution; b) adding an initiator and an accelerator to the first solution, thereby producing a precursor solution; and
c) casting the precursor solution, thereby producing the adhesive material.

### BRIEF DESCRIPTION OF THE DRAWINGS

FIG. 1 shows a schematic representation demonstrating strong and thermo-switchable soft sticky PNIPAm adhesive. Left: at room temperature, the adhesive is sticky at the surface and highly viscoplastic in the bulk, providing strong adhesion, as indicated by the stretchable fibrils emerging from the polymer network during debonding from an adherend. Right: at an elevated temperature (T>32° C.), the rubbery PNIPAm network transforms to a condensed glassy-like network, inducing significant chain retraction and water migration at the interface, leading to near-vanishing adhesion with no fibril.

FIG. 2 shows graphs demonstrating synthesis-property relationship for adhesion strength and characterization of adhesion switching. The adherend is chosen as glass for all the data. (a) The adhesion strength increases with the mass ratio of nanoclay, M_{clay}/M_{NIPAm}. The amounts of initiator and accelerator are fixed as M_{APS}/M_{NIPAm}=3.818×10⁻³ and M_{TEMED}/M_{NIPAm}=72.51×10⁻³, respectively. (b) The adhesion strength increases with water content, reaches a peak, and then decreases. (c) The adhesive is switchable for 10 consecutive cycles, showing high adhesion strength at room temperature (T=25° C.) and near-vanishing adhesion strength (about 0.6 kPa) at high temperature (T>32° C.). The different values in the legend represent different mass ratios of nanoclay, M_{clay}/M_{NIPAm}=0.476, 0.317, and 0.238. (d) Measurement of switching time. The constant stress plateau (green curve) represents the adhesion stress generated by a dead weight being attached to the adhesive gripper, which is further lifted by the tensile tester. The temperature is measured by the in situ temperature sensor on the heater (red curve). The switching time (14 s) is measured as the interval from activating the heating to the moment of sudden drop of the stress. All error bars represent the standard deviation of more than 3 independently measured samples.

FIG. 3 shows a graph demonstrating that the adhesive forms strong and highly switchable adhesion with diverse materials including glass, PET (polyethylene terephthalate), PE (polyethylene), PP (polypropylene), PTFE (polytetrafluoroethylene), PMMA (poly(methyl methacrylate)), silicone rubber, aluminum, copper, steel, and wood. The adhesion at room temperature remains nearly the same after 10 cycles of switching. For all materials, the residual adhesion strength at high temperature is around or lower than 1 kPa, which are shown by the negligible green and yellow columns. See Table 1 for all the measured values. All error bars represent the standard deviation of more than 3 independently measured samples.

FIG. 4 shows graphs and photographs demonstrating self-healing of the reusable adhesive. (a) Broken adhesive pieces are patched together, reshaped, and allowed to heal for 24 hours. The adhesion strength after healing is nearly identical to that of the freshly made adhesive. (b) The adhesive can be dried, grinded into small particles, dry-stored for 10 days, re-swollen in water, patched together, and reused. (c) The stored adhesive almost completely recovers its adhesion strength at room temperature and excellent switching at high temperature, even after 10 switching cycles. (d) The complete reusability extends to adherends made of diverse materials. All error bars represent the standard deviation of more than 3 independently measured samples. The scale bars in (a) and (b) are 1 cm.

FIG. 5 shows photographs demonstrating pick-and-release applications of the strong and switchable adhesive. (a) Pick-and-release of objects of various materials, shapes, sizes, and weights, all with switching time around 10 s. See Table 3 for detailed data. The scale bar is 1 cm. (b) Under programmed heating, the gripper can pick and release objects for multiple cycles. The scale bar is 4 cm. (c) & (d) Selective release or pick-up of spherical beads (top) and flat coin batteries (bottom) by only heating the center of adhesive. The scale bars are 1 cm.

FIG. 6 shows photographs demonstrating the process of thermo-induced phase transition in a bulk PNIPAm gel. The white color represents the condensed polymer network. The heater with temperature set as 90° C. is attached on top of a bulk PNIPAm gel with a thickness of 1.5 cm. The adhesive is translucent initially, and gradually becomes white, indicating the thermo-induced phase transition of the PNIPAm network. The scale bar is 3 cm.

FIG. 7 shows a schematic representation and a plot demonstrating characterization of adhesion strength by the probe-pull experiment. (a) The gripper and the adherend are fixed to the top and bottom grippers of an Instron tensile tester (34TM-5). The Instron tester conducts a tensile test with a fixed speed of 0.1 mm/s to measure force-displacement curve. (b) The measured force-displacement shows a peak force. The adhesion strength is calculated as the peak force divided by the initial cross-sectional area of the adhesive.

FIG. 8 shows a schematic representation and a plot demonstrating characterization of adhesion energy. (a) Schematics of a double-peeling test. The bilayer of adhesive and adherend is attached with stiff backing layers via super glue to constrain the elastic deformation during peeling. For stiff adherends, a 90-degree peeling test is used instead of double-peeling. (b) A representative force-displacement curve measured by the peeling test. The crack speed is prescribed as 1 mm/s. The curve reaches a steady state with a plateau when the peeling displacement increases. The adhesion energy is calculated as Γ=2F/w in double peeling, and Γ=F/w for 90-degree peeling, where F is the measured steady-state force and w=1 cm is the sample width.

FIG. 9 shows plots demonstrating the effect of initiator amount, M_{Aps}/M_{NIPAm}, on the adhesion strength, with different fixed values of (a) M_{Clay}/M_{NIPAm}, with M_{TEMED}/M_{NIPAm}=7.251×10⁻³, and (b) M_{TEMED}/M_{NIPAm}, with M_{Clay}/M_{NIPAm}=0.317. The adherend is chosen as glass for all the data here. All error bars represent the standard deviation of more than 3 independently measured samples.

FIG. 10 shows plots demonstrating the effect of initiator amount, M_{Aps}/M_{NIPAm}, on the adhesion energy, with different fixed values of (a) M_{Clay}/M_{NIPAm}, with M_{TEMED}/M_{NIPAm}=7.251×10⁻³, and (b) M_{TEMED}/M_{NIPAm}, with M_{Clay}/M_{NIPAm}=0.476. The adherend is chosen as PET for all the data here. All error bars represent the standard deviation of more than 3 independently measured samples.

FIG. 11 shows plots demonstrating the effect of nanoclay amount, M_{Clay}/M_{NIPAm}, on the (a) adhesion strength with glass and (b) adhesion energy with PET. The amount of initiator is fixed as M_{APS}/M_{NIPAm}=3.818×10⁻³. All error bars represent the standard deviation of more than 3 independently measured samples.

FIG. 12 shows a plot demonstrating adhesion strength with different adherends and various mass ratios of nanoclay, M_{Clay}/M_{NIPAm}=0.238, 0.317, and 0.476. The amounts of initiator and accelerator are fixed as M_{APS}/M_{NIPAm}=3.818×10⁻³ and M_{TEMED}/M_{NIPAm}=72.51×10⁻³, respectively. All error bars represent the standard deviation of more than 3 independently measured samples.

FIG. 13 shows a plot demonstrating that the measured adhesion strength increases with the compressive pressure applied to attach the adhesive to a glass adherend. In experiments, various weights (0 kg, 0.5 kg, 1 kg, 2 kg, and 3 kg) are placed on top of the adhesive (circular shape with diameter of 2 cm) for 5 min to provide the compressive pressure. All error bars represent the standard deviation of more than 3 independently measured samples.

FIG. 14 shows photographs and thermal images demonstrating that a gripper can successfully pick up an aluminum plate at room temperature, but cannot pick up an identical plate that has been preheated to precisely 32° C. The scale bar is 3 cm.

FIG. 15 shows schematic representations of the characterization of cyclic switching. The top of the adhesive gripper is connected to the Instron gripper while the PNIPAm adhesive at the bottom is attached to an adherend. The adherend is fixed to a hot plate (not shown), and the hot plate is fixed to the bottom of the Instron tensile tester. In one switching cycle, the PNIPAm adhesive is first brought into contact with the adherend with a gentle compression at room temperature to form the adhesion. The adherend is subsequently heated to 75° C. set by the hot plate. When the adhesive becomes completely opaque due to the thermo-induced phase transition, it is detached from the adherend. A subsequent switching cycle is started after approximately 1 minute to ensure all materials are cooled back to room temperature.

FIG. 16 shows a plot demonstrating the measured adhesion strength over an extended number of switching cycles. A slight amount of deionized water is sprayed to the surface of adhesive after each cycle to keep the adhesive from drying due to the continuous heating. The adhesion strength is measured after 1, 10, and 30 switching cycles. All error bars represent the standard deviation of more than 3 independently measured samples.

FIG. 17 shows schematic representations of the adhesive gripper integrated with a ceramic heater and in situ temperature sensor. The heater is programmed by a temperature controller (not shown). The PNIPAm adhesive is attached to the bottom of the heater.

FIG. 18 shows schematic representations and plots of the characterization of switching time. (a) The top of the adhesive gripper is connected to the Instron tensile tester while the PNIPAm adhesive at the bottom is attached to a steel dead weight of 250 g with a diameter 1.7 cm. When the heater is set with a target temperature of 40° C., the gripper can hold the dead weight for about 14 s, followed by the drop of the dead weight and thus the measured stress. (b) At room temperature, the gripper can hold the weight for more than 100 s, shown by the constant stress plateau of about 11 kPa measured by the tensile tester. (c) When the heater is on with a target temperature of 40° C., the adhesion stress undergoes an abrupt drop after 14 s, which represents the switching time.

FIG. 19 is a graph demonstrating adhesion energy with different adherends. The composition of the PNIPAm adhesive is M_{Clay}/M_{NIPAm}=0.476, M_{APS}/M_{NIPAm}=2.863×10⁻³, M_{TEMED}/M_{NIPAm}=72.51×10⁻³, and M_{water}/M_{gel}=0.7963. All error bars represent the standard deviation of more than 3 independently measured samples.

FIG. 20 shows plots demonstrating contact angle of various adherends and their corresponding (a) adhesion strengths and (b) adhesion energies. All error bars represent the standard deviation of more than 3 independently measured samples.

FIG. 21 shows photographs of broken adhesive after a probe-pull experiment. The scale bar is 2 cm.

FIG. 22 shows photographs demonstrating that with a contact area of 3.14 cm², the adhesive gripper can pick and release a total weight of 2.4 kg, equivalent to a stress of 76 kPa. The scale bar is 5 cm.

FIG. 23 is a schematic representation of selective release of small objects. A circular thermal insulator made of acrylic is placed around the central heater in the gripper, such that only the central part of the adhesive layer increases its temperature by heating. When the heater is off at room temperature, the adhesive is sticky everywhere, and can pick up all the objects. When heater is on, only the central heating zone increases its temperature above 32° C., thus releasing the object inside the zone.

### DETAILED DESCRIPTION

Many biological systems can switch between strong adhering and non-adhering states to various materials with complex shapes and sizes in a reversible manner. Examples include the fibrillar-structured attachment pads of beetles, flies, spiders, and geckos¹. Developing highly switchable adhesion in human-engineered systems is attractive in advancing a broad range of emerging technologies, such as biomimetic climbing and flying robots in complex environments^{2, 3}, additive manufacturing via rapid assembly of functional voxels^{4, 5}, precision in-body wound dressing and drug delivery^{6,7}, and wearable and implantable biomedical devices with multifunctional human-machine interfaces^{8, 9}.

Switchable adhesion has been achieved in engineered systems in multiple ways¹⁰, including pneumatic suction^{11, 12}, electrostatic force^{2, 13}, modulus regulation^{14, 15}, gecko-inspired surfaces^{16, 17}, and stimuli-responsive soft sticky adhesives¹⁸⁻²⁰. Among them, enabling switchable adhesion in soft sticky adhesives, also known as pressure-sensitive adhesives (PSAs)^{21, 22} possesses special advantages. A switchable soft sticky adhesive can adhere to small and non-flat objects made of various materials. Compared to systems that require stimuli or energy input to activate the adhesion, an adhesive that is sticky by default and only on-demand switchable to the non-sticky state will consume less energy, hence facilitating its large-scale deployment. Commercial PSAs have been widely used in packaging, textile, electronics, manufacturing, and civil infrastructure²³. As a result, switchable PSAs are promising to address the emerging global challenge of sustainability, by enabling on-demand dismantling and recycling of devices²⁴.

Existing switchable soft sticky adhesives are generally based on the following mechanisms.^{10, 18-20} Thermo-switchable adhesives soften, decompose, or change volume with heat to enable debonding,²⁵⁻²⁸ but these processes often leave residues or cause irreversible switching. Photo-switchable adhesives, such as dicing tapes in microelectronic fabrication, contain photo-reactive molecules that alter the rheology under light illumination, enabling bonding or debonding²⁹⁻³⁴ However, photo-reactions raise concerns about their long-term stability and irreversible switching. Rate-dependent PSAs are used in applications like transfer printing,^{35, 36} offering strong adhesion with fast peeling and weak adhesion with slow peeling to enable controlled pick-and-place. Despite ease of use, they often involve a narrow switching range (e.g., low adhesion before switching or high residual adhesion after switching). Shape memory polymer (SMP) adhesives form adhesion by heating to their rubbery phase for conformal contact and then cooling to their glassy phase to “lock” the contact and enhance the adhesion strength due to cooling-induced stiffening.^{16, 37-39} Reheating is required to deactivate the adhesion. SMP adhesives offer strong and reversible adhesion but require multiple operations and often leave nontrivial residual adhesion (strength>10 kPa) after switching. Finally, switchable PSA-like hydrogel adhesives have recently emerged, utilizing special chemistries,⁴⁰ phase transformation,⁴¹ solvent migration,⁴² or one of the above mechanisms (e.g., similar to shape locking of SMP)⁴³. However, these adhesives have limitations including specified adherend materials (such as another hydrogel or tissue), high residual adhesion after switching (>10 kPa), low adhesion strength before switching (around 30 kPa), slow switching speed (around minutes), or irreversible switching. Overall, it remains a significant challenge for existing soft sticky adhesives to combine high switchability, reversible switching, facile switching operation, and applicability to diverse materials, shapes, and sizes.

In some embodiments, the present disclosure relates to a highly switchable and reversible soft sticky adhesive based on thermal-induced phase separation in a thermo-responsive polymer, such as poly(N-isopropylacrylamide) (PNIPAm) hydrogel. The hydrogel is toughened by nanoparticles, such as nanoclay particles, as noncovalent crosslinkers, enabling an adhesion strength of 60-80 kPa to various adherends at room temperature. At temperatures over 32° C., this adhesion is almost completely switched off with a residual strength of around 1 kPa. The present disclosure demonstrates a synthesis-property relationship including the effects of initiator, accelerator, nanoclay crosslinker, and water content on the adhesion and its switching in the resulting material. The adhesion switching was reversible for many cycles. Integrated into a customized gripper with predesigned heating zones, the adhesive enabled selective pick-and-release of objects with various materials, shapes, sizes, and weights. The switching time was governed by thermal conduction through the adhesive layer, which was around 10 seconds with an adhesive layer of 1 mm. The adhesive was self-healing, and can be recycled, dried, stored, reswollen, and reused with nearly intact properties. In some embodiments, the synergy of bulk dissipation and stimuli-responsive interfacial interaction can be extended to various thermo-responsive polymer systems to expand the design space of switchable soft sticky adhesives.

The presently disclosed design principle for the thermo-switchable soft sticky adhesive is two-fold. First, a PSA-like soft sticky polymer network has many long chains on its surface. These chains can form densely packed noncovalent (e.g., van der Waals) bonds with various materials (herein called adherends) without any special surface treatment, leading to strong adhesion (FIG. 1 left). During debonding, stretchable fibrils emerge from the polymer network (FIG. 1 left), bridge the crack at interface, transmit the local stress to the bulk polymer network, and induce large energy dissipation via the breaking of other sacrificial bonds in the bulk^{21, 44} To switch off the adhesion, the sticky polymer network undergoes a reversible stimuli-responsive phase transition, significantly changing its bulk or surface property such as a non-sticky surface due to chain retraction (FIG. 1 right) and solvent migration, leading to greatly reduced or vanishing adhesion.

In some embodiments, this design principle is demonstrated in a thermo-switchable sticky poly(N-isopropylacrylamide) (PNIPAm) hydrogel crosslinked by nanoclay. The nanoclay particles were used as crosslinker since they form a large number of physical (noncovalent) bonds with PNIPAm chains^{45, 46}, enabling a highly viscoplastic polymer network with large bulk energy dissipation during debonding. In some embodiments, the amount of initiator, accelerator, crosslinker, and water content used the synthesis provided strong adhesion with diverse materials at room temperature. In switching, thermal stimulus was used since heat can be easily converted from various other stimuli including electricity, magnetic field⁴⁷, and light⁴⁸. At temperature above 32° C., the rubbery PNIPAm network transformed to a condensed glassy-like network (see the process of this phase transition in FIG. 6)^{49, 50}, inducing significant polymer chain retraction and water migration at the interface. This is evidenced by a completely non-sticky PNIPAm network at high temperature, with no fibril forming during the debonding from an adherend, indicating a near-vanishing adhesion after switching (FIG. 1 right).

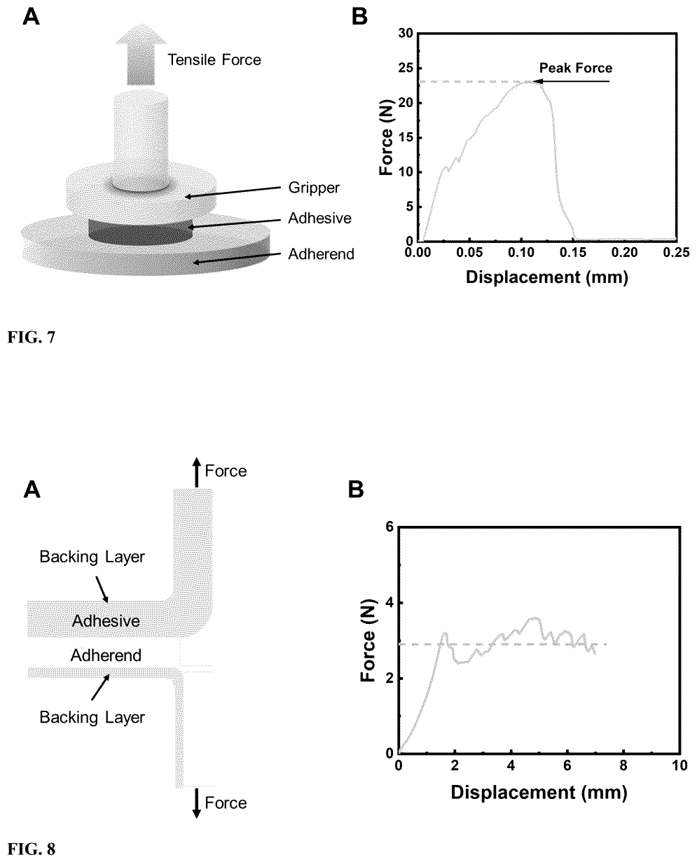

To provide strong adhesion at room temperature, the polymer network needs many long chains on its surface to enable sufficient interfacial bonds, a percolated network in its bulk to effectively transmit the stress from the interface, and additional bulk energy dissipation from the breaking of physical bonds between nanoclay and polymer chains. These processes depend on the synthesis parameters including the amounts of initiator, accelerator, nanoclay crosslinker, and water solvent. During synthesis, NIPAm monomers interlink to form PNIPAm chains via free-radical polymerization assisted by the initiator and accelerator, and PNIPAm chains simultaneously crosslink into a network by forming physical bonds with nanoclay. In some embodiments, the mass of NIPAm monomers was fixed, and the amounts of initiator (ammonium persulfate, APS), accelerator (N,N,N′,N′-tetramethylethylenediamine, TEMED), nanoclay, and water solvent were varied to synthesize PNIPAm with different compositions. The adhesion strength was characterized using the probe-pull experiment (FIG. 7) and adhesion energy using the 90-degree peeling or double-peeling experiment (FIG. 8), both at room temperature.

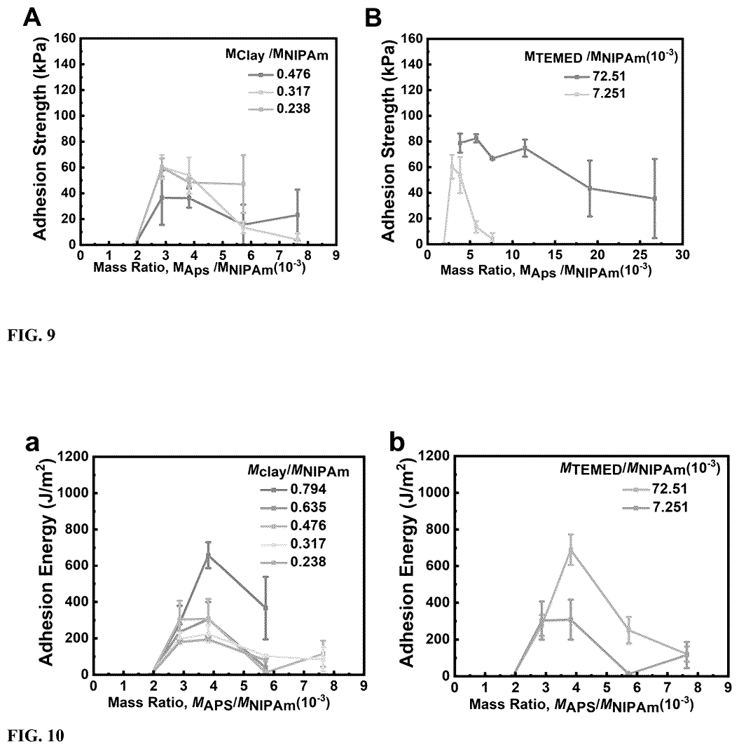

In some embodiments, all other parameters were fixed and the mass ratio of initiator to PNIPAm, M_{APS}/M_{NIPAm}, was varied. The synthesized PNIPAm always reached the highest adhesion strength (FIG. 9) or adhesion energy (FIG. 10) at an intermediate M_{APS}/M_{NIPAm}. This intermediate value was slightly different for adhesion strength and adhesion energy, and depended on other fixed parameters. The intermediate amount of initiator can be understood by the following molecular picture. When M_{APS}/M_{NIPAm} is too low, during polymerization, a percolated polymer network cannot form due to insufficient initiating points, leading to weak or no adhesion. When M_{APS}/M_{NIPAm} is too high, many polymer chains are initiated simultaneously during polymerization, but quickly terminated by neighboring initiators, leading to many dangling chains with short chain lengths⁵¹. The short chains result in PNIPAm with low adhesion strength, following the classical Lake-Thomas model for fracture^{52, 53}, consistent with the experimental observation. This non-monotonic effect of initiator is further coupled with other synthesis parameters such as the mass ratios of nanoclay (FIGS. 9(a) and 10(a)) and accelerator (FIGS. 9(b) and 10(b)). For example, the adhesion was greatly enhanced with the increase of accelerator, which is likely due to the increased number of dangling chains in the system.

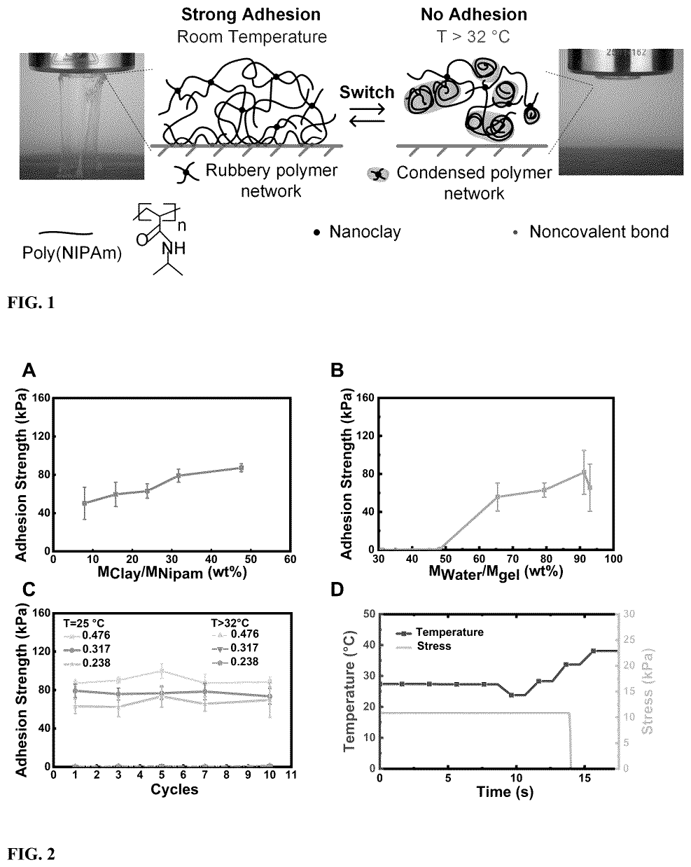

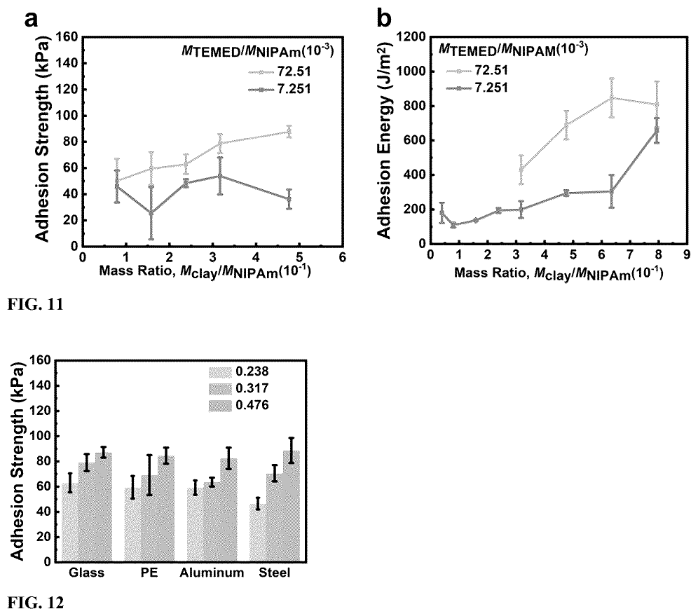

In some embodiments, the amounts of initiator and accelerator were fixed, and the effects of nanoclay (FIG. 2(a) & FIG. 11) and water content (FIG. 2(b)) were investigated. Overall, both the adhesion strength and adhesion energy increased with the mass ratio of nanoclay, M_{clay}/M_{NIPAm}, since more nanoclay led to more physical bonds with polymer chains, enhancing the bulk energy dissipation during debonding. This effect of nanoclay was consistently observed in adhesion strengths with various adherends (FIG. 12). However, in certain compositions, too much nanoclay led to decreased adhesion strength (FIG. 11(a)) or adhesion energy (FIG. 11(b)). This is possibly due to the competing effects of nanoclay as crosslinkers and dissipators: when the amount of nanoclay increases, the former embrittle a network and the latter toughen a network. Such competing effects have been observed and discussed in other soft material systems such as double-network hydrogels^{54, 55}. Besides nanoclay, the adhesion strength increased with the mass ratio of water solvent M_{water}/M_{gel} until a peak value, and subsequently decreased (FIG. 2(b)). In some embodiments, low water content (e.g., <50 wt %) led to a non-sticky surface, likely due to the collapse of long chains on the surface. On the other hand, a too high water content (e.g., >94 wt %) caused large swelling of the gel, leading to lower adhesion due to the decreased surface density of chains and a more brittle bulk material^{56.}

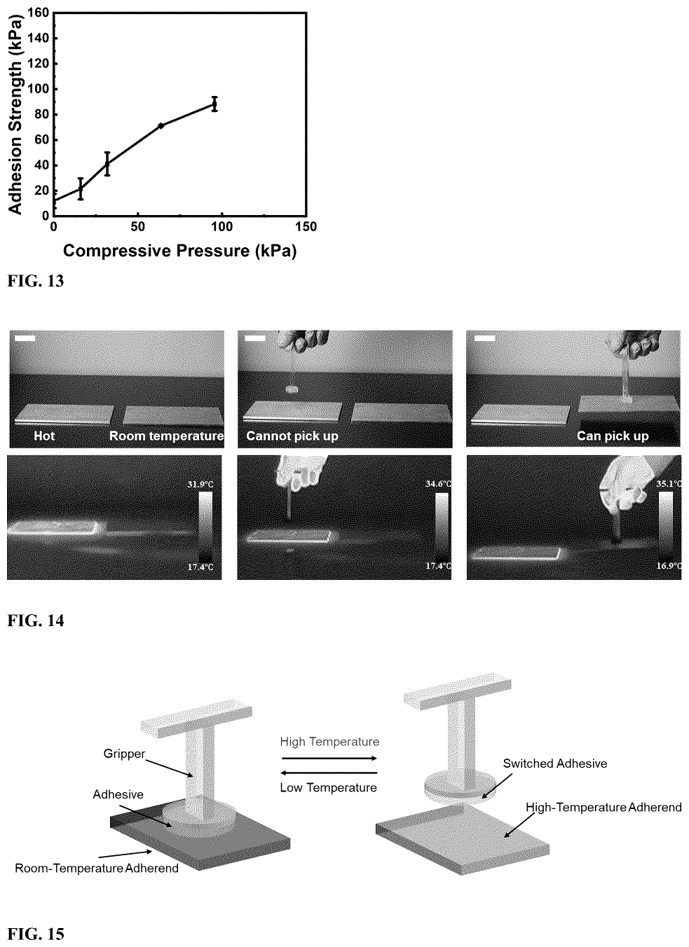

In some embodiments, with all the synthesis parameters, the adhesion strength increased with the compressive pressure applied to attach the adhesive to an adherend (FIG. 13). This pressure-sensitivity again alludes to the nature of densely packed physical bonds at the interface—a high pressure during attachment promotes the contact between the surface chains and adherend.

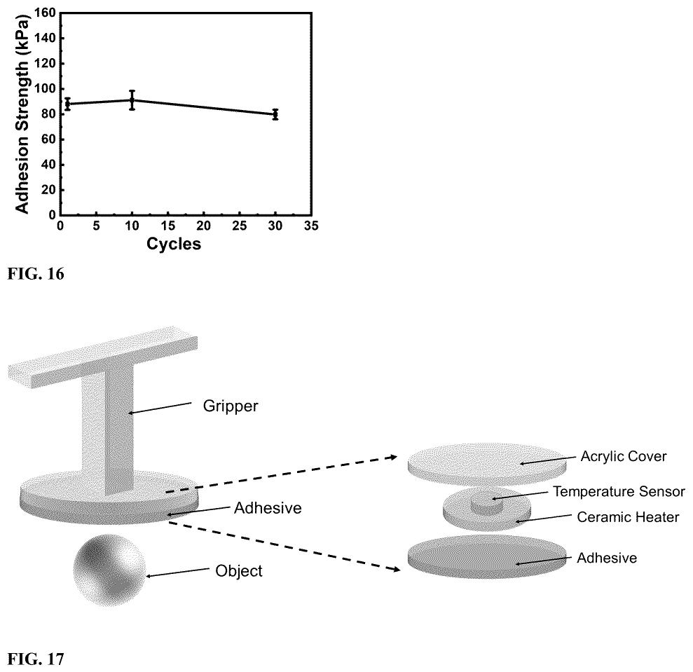

In some embodiments, the synthesized adhesive was highly switchable between about 87 kPa at room temperature and nearly no adhesion (about 0.6 kPa) at temperature above 32° C. (FIG. 2c). This switching temperature is consistent with the lower critical solution temperature (LCST) of PNIPAm that induces its phase separation⁵⁷. A gripper with the adhesive attached to its bottom end was used To quantitatively validate this critical temperature of 32° C. As shown in FIG. 14 with the assist of thermal imaging, the gripper successfully picked up an aluminum plate at room temperature, but could not pick up an identical plate that has been preheated to precisely 32° C. The room-temperature plate attached to the gripper was subsequently heated. When its temperature increased to slightly above 32° C., the adhesive underwent phase transition indicated by the opaque color, and was easily detached from the plate. This thermal switching sustained 10 switching cycles (FIGS. 2(c) and 15). Over many cycles of switching, the adhesive gradually lost water due to the continuous heating. Nevertheless, with a slight spray of water on its surface after each switching cycle, the lifetime of switching was extended, e.g., to more than 30 cycles as shown in FIG. 16.

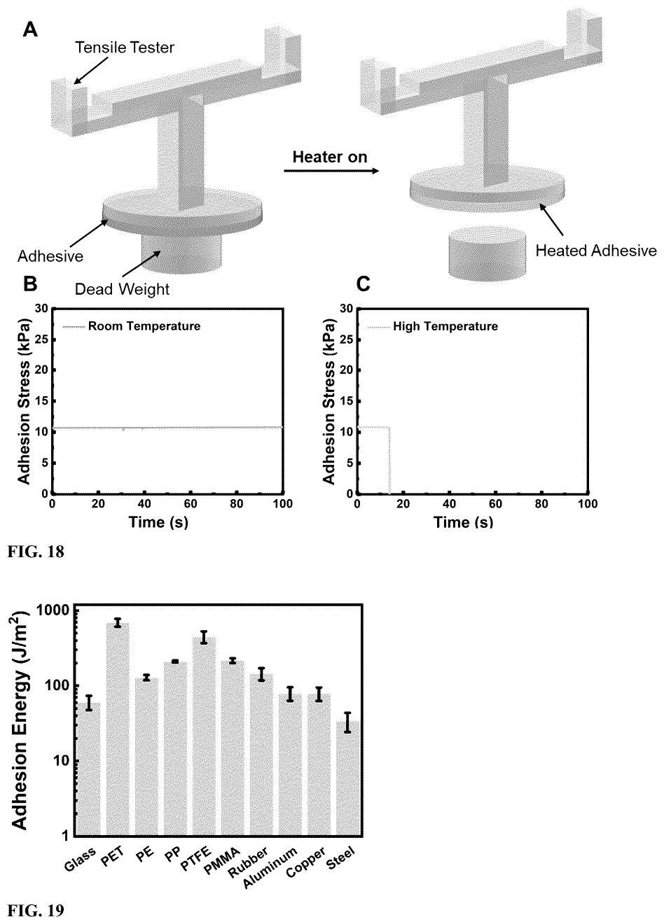

To further characterize the switching time in a practical application of pick-and-release, the adhesive gripper was integrated with a heater and an in situ temperature sensor (FIG. 17). A dead weight was attached to the gripper, and the gripper, adhesive, and weight were lifted using an Instron tensile tester (FIG. 18(a)). At room temperature, the gripper can hold the weight for more than 100 seconds, shown by the constant stress plateau measured by the tensile tester (FIG. 18(b)). By contrast, with a heating towards 40° C., the gripper can only hold the dead weight for about 14 seconds (FIGS. 2(d) and 18(c)), where the detachment occurred within 2 seconds once the temperature of the heater reached 32° C. This switching time of 14 seconds is consistent with the time scale of thermal diffusion throughout the thickness of the adhesive, t˜h²/Dt. Taking h˜1 mm as the adhesive thickness and Dt˜10⁻⁷ m²/s as the thermal diffusivity of water provides t˜10 s. In other words, heat needs to be conducted from the heater side to the adhering side throughout the adhesive thickness to activate the polymer chain retraction. Since t scales quadratically with the thickness h, a thinner adhesive can further reduce the switching time.

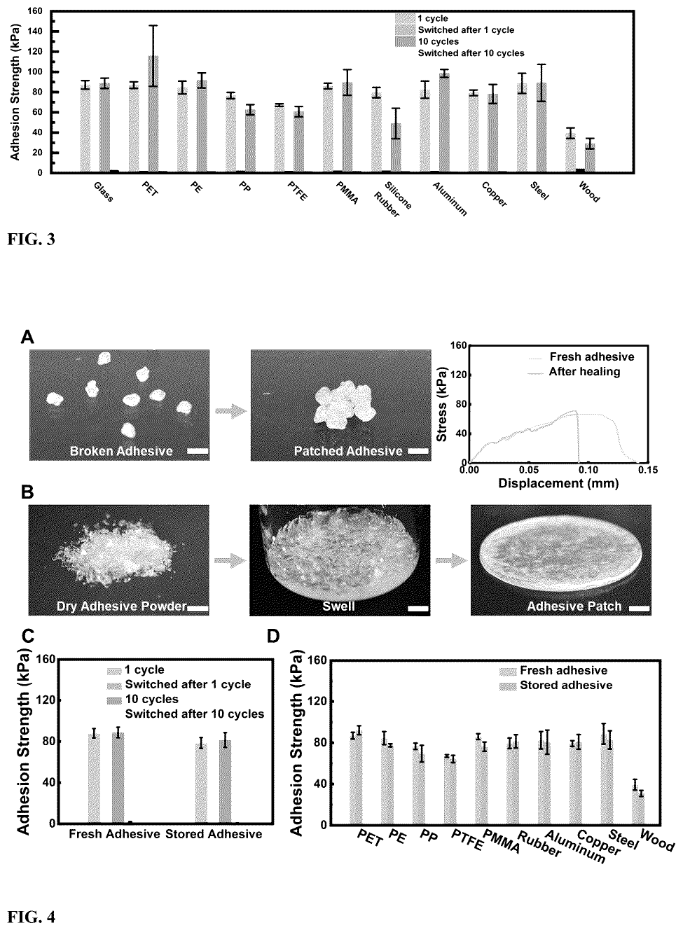

In some embodiments, the strong and switchable adhesion for many switching cycles applied to adherends made of diverse materials, including glass, plastics, elastomers, metals, and wood (FIG. 3 & Table 1). For nearly all the materials investigated, the adhesion strength at room temperature was around 80 kPa in both the first and tenth cycles. The lowest adhesion strength was measured with wood, 39.34±5.22 kPa before any switching and 29.15±5.23 kPa after 10 cycles of switching. At high temperature after switching, the residual adhesion strength was mostly lower than 1 kPa, with the highest of 2.82±0.77 kPa measured with wood too. Both the lower room-temperature adhesion and higher switched residual strength for wood might be attributed to its high surface roughness: at room temperature, a rough surface reduces the effective contact area hence lowers the adhesion; when being switched at high temperature, the rough surface forms certain mechanical interlocking with the stiffer condensed PNIPAm network, giving rise to residual adhesion.

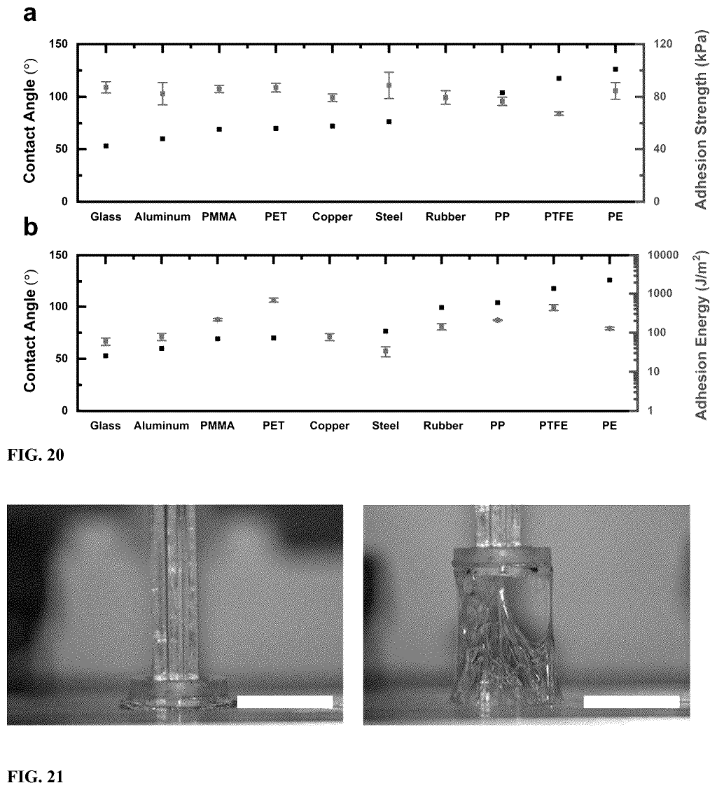

In contrast to the relatively consistent adhesion strength with various materials, the adhesion energy varied over orders of magnitude (FIG. 19), with the highest of about 600 J/m² for PET, and the lowest of about 30 J/m² for steel. Nevertheless, these values were still much higher than the adhesion energy induced by physical bonds in many other established methods such as using nanoparticles⁵⁸. To investigate this large discrepancy in adhesion energy among different materials, contact angle measurements for all the adherends were conducted and ranked together with their corresponding adhesion strengths (FIG. 20(a)) and adhesion energies (FIG. 20(b), also see detailed measured values in Table 2). With the increase of contact angle, an adherend was more hydrophobic, and the adhesion strength showed a slight decrease except for the case of PE. This slight decrease of adhesion strength with the contact angle, though not significant and with certain scattering, may be attributed to the osmocapillary effect on adhesion that has been recently reported⁴². When the adhesive gel is in contact with an adherend, their interfacial gap is filled by water due to the capillary force, and this thin layer of water is under tension due to the osmotic pressure from the gel, thus providing adhesion at the interface. This osmocapillary adhesion decreases with the hydrophobicity of the adherend, since a more hydrophobic adherend provides less capillary force to pull water out from the gel. On the other hand, a more hydrophobic adherend promotes the formation of more physical bonds between the surface chains and adherend, thus enhancing the adhesion. With the competition between these two mechanisms, the adhesion strength is jointly influenced by the interfacial water layer and surface chains, but the former does not effectively contribute to the adhesion energy. This is due to the poor resistance of water to shear deformation, resulting in its minimal capacity to transmit the local crack-tip stress to the bulk adhesive to elicit its energy dissipation⁵⁹.

In some embodiments, the adhesive showed good self-healing due to the reversible physical bonds between nanoclay and PNIPAm chains⁶⁰. After a probe-pull experiment (FIG. 21), the broken adhesive pieces were collected, patched together, reshaped using a mold, and allowed to heal for 24 hours (FIG. 4(a)). The adhesion strength after healing is nearly identical to that of the freshly made adhesive (FIG. 4(a) right). Furthermore, the adhesive can be dried, grinded into small particles, stored for 10 days, re-swollen in water, patched together, and reused (FIG. 4(b)). The stored adhesive almost completely recovers its adhesion strength at room temperature and excellent switching at high temperature, even after 10 switching cycles (FIG. 4(c)). This complete reusability extends to adherends made of diverse materials (FIG. 4(d)).

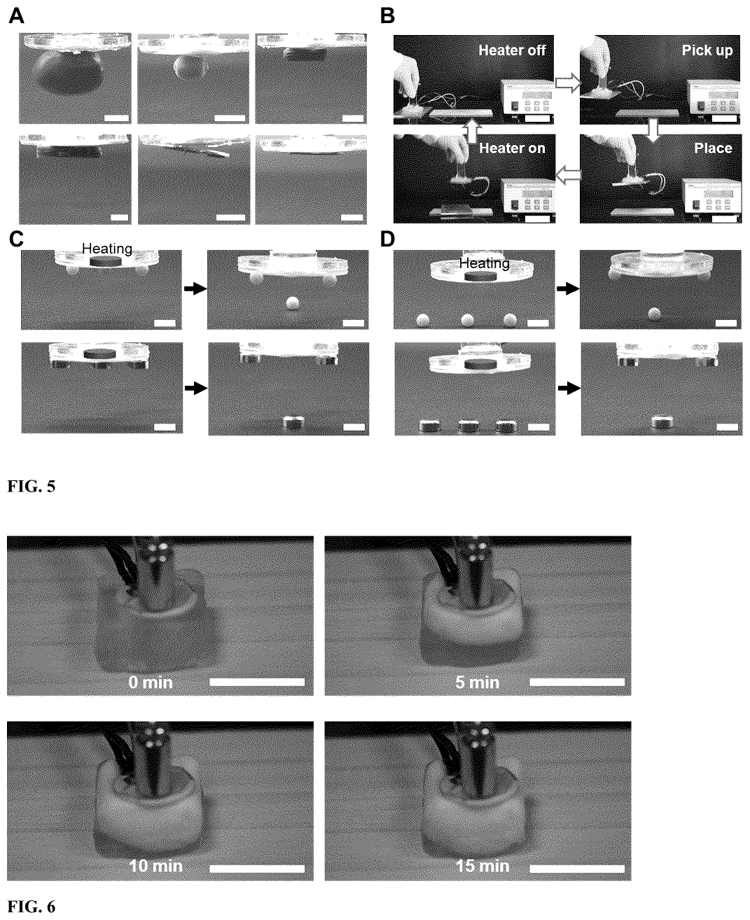

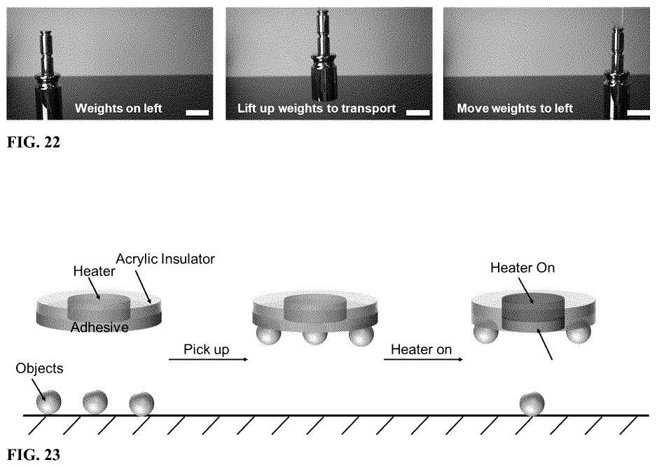

In some embodiments, the strong adhesion and near-vanishing residual adhesion after switching enabled pick-and-release of objects of various materials, shapes, sizes, and weights, all with switching time around 10 seconds (Table 3). The adherends demonstrated here include grape tomato (8.7 g, switching time of 4 seconds), lotus seed (1.1 g, 3 seconds), wooden rod (0.25 g, 11 seconds), plastic screw (0.35 g, 5 seconds), copper screw (1.9 g, 10 seconds), and steel nail (0.32 g, 9 seconds) (FIG. 5(a)). In addition, with a contact area of 3.14 cm², the adhesive gripper could lift a total weight of 2.4 kg, equivalent to a stress of 76 kPa (FIG. 22). Under a programmed heating, this pick-and-release was reversible for multiple cycles with the same switching time of about 10 seconds, as shown in FIG. 5(b).

In some embodiments, selective pick-and-release mechanism was demonstrated by spatially programming the heating zones on the adhesive gripper. To do so, a circular thermal insulator was placed around the central heater in the gripper, such that only the central part of the adhesive layer increased its temperature by heating (FIG. 23). When the heater was turned off at room temperature, the adhesive was sticky everywhere, and could pick up all the objects (FIG. 5(c) left). Activating the heater subsequently triggered the selective release of only the central object, with the remaining objects still attached to the gripper (FIG. 5(c) right) due to the pre-designed central heating zone. The same setup further enabled a selective pick-up when activating the heater during the object attachment, as shown in FIG. 5(d).

In some embodiments, the present disclosure relates to a thermo-switchable soft sticky adhesive based on thermo-responsive phase separation in the PNIPAm hydrogel. The adhesive showed strong adhesion at room temperature and near-vanishing adhesion at elevated temperature with diverse materials. The thermal switching was facile and reversible for many cycles. The switching time of 10 seconds was faster than or comparable to most state-of-the-art switchable adhesives, and can be further reduced by a thinner adhesive layer that enables faster thermal conduction. The adhesive was fully reusable due to its complete self-healing. Integrated with predesigned heating zones on a customized gripper, the adhesive enabled versatile pick-and-release of objects with various materials, shapes, sizes, and weights.

In designing strong and tough soft adhesives, the multiscale energy dissipation is reflected by a classical equation, Γ=Γ₀[1+f_{d}(v, T)]^{22, 61-63}, where Γ is the adhesion energy, Γ₀ is the intrinsic toughness determined solely by the local process around the interface during debonding, and f_{d} is an amplifying factor from nonlocal energy dissipation that often depends on the crack speed v and temperature T. In the current system, the near-vanishing adhesion at high temperature is a direct result of switching Γ₀ to nearly zero, through the interfacial chain retraction and water migration by the condensed network after phase transition. This classical equation thus provides a new way of designing switchable adhesion with a synergistic division of labor. On the one hand, a strong and tough adhesive can be designed by introducing well-established toughening mechanisms in the bulk that greatly enhance fa, such as the strengthening and toughening through interpenetrating polymer networks (e.g., PNIPAm with calcium-alginate⁶⁴, poly(acrylic acid)⁶⁵, or poly(vinyl alcohol)⁶⁶). Simultaneously, a highly switchable adhesive can be achieved by eliminating Γ₀ via stimuli-responsive phase transition, such as the thermo-responsive chain retraction in a broad range of lower critical solution temperature (LCST)⁶⁷ and upper critical solution temperature (UCST) polymers⁶⁸.

Switchable covalently or noncovalently bonded adhesion based on PNIPAm have been reported in recent years^{41, 64, 69-74}. However, upon heating and thermal-induced phase separation, some of them show enhanced adhesion^{64, 70-74}, while others show reduced adhesion^{41, 69}. This discrepance can be explained using Γ=Γ₀[1+f_{d}(v, T)]. When the intrinsic toughness Γ₀ does not vanish at high temperature due to covalent bonding or mechanical interlocking, the PNIPAm adhesive will show enhanced adhesion from the bulk stiffening and increased energy dissipation in the condensed network after phase separation. By contrast, for the current soft sticky PNIPAm adhesive based on noncovalent interfacial bonds, the near-zero adhesion at high temperature is attributed to the greatly reduced Γ₀ due to the hypothesized chain retraction and water migration after phase separation. Finally, for potential applications that require a different switching temperature, the LCST can be tuned by introducing ionic liquids into the PNIPAm gel, in a range between 24° C. and 56° C. by controlling the type and amount of ionic liquid⁷⁵.

### Overview of Disclosure

Pressure-sensitive adhesives (PSAs) are widely used in daily life and industrial application such as duct tapes, band-aid, post-it, construction, electronics, and biomedical devices. Existing commercial PSAs have strong adhesion, but their adhesion is not switchable/reversible, i.e., switchable between attachment and detachment repeatedly, by an external control other than mechanical force. In some embodiments, the present disclosure relates to a PSA that is highly switchable between adhering and non-adhering states with external objects via temperature change. The disclosed switchable PSA has several performances that no existing engineering system or material has achieved, as detailed in the section below.

In some embodiments, the PSA is made of a thermo-responsive sticky poly(N-isopropylacrylamide) (PNIPAM) hydrogel crosslinked by nanoclays. The fabricated material has a highly dissipative polymer network containing many free-end dangling chains that form tough adhesives at room temperature, and become non-adhesive under an external heat towards temperature over 35° C. The adhesion switching of the PSA is induced by the thermo-responsive phase separation of the PNIPAM polymer.

### Advantages, Improvements, Problems Solved

1. Strong adhesion to diverse materials: the disclosed PSA has strong adhesion (adhesion strength˜80-100 kPa, comparable to commercial duct tapes) to a diverse group of materials, such as plastics, elastomers, wood, glass, and metals.
2. The adhesion is highly switchable between the above adhesion strength and nearly no adhesion (strength˜0.5 kPa) by temperature change.
3. The switching time between adherence and non-adherence is currently shown to be 3-10 seconds and can be potentially further reduced by optimizing the material geometry.
4. This switchable adhesion is reversible and repeatable, continuously for at least 10 cycles.
5. One special advantage of the disclosed PSA over some other existing switchable adhesion systems in the academic field is its user-friendly and diversity: e.g., the system building on this material can work for small and non-flat objects, but many other systems (such as a negative-pressure sucking system or artificial gecko-surface) cannot do it.
6. The adhesive is self-healing and can be easily stored as a paste.
7. The adhesive is water-based, can be completely dried and stored, and re-swollen to recover its good feature above.

### Potential Uses

1. Advanced manufacturing: a manufacturing system with pick-and-place for digital material assembly/disassembly. The disclosed switchable PSA can serve as the material interface that enables such a manufacturing platform.
2. Wearable devices: the switchable adhesive can serve as a smart material interface for wearable/portable devices.
3. Robotics: this material can be used to enable climbing and flying micro-robots.
4. Sustainability: the switchable PSA can enable devices with on-demand dismantling after reaching their lifetime, to help recycle components.

### Definitions

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

In order for the present invention to be more readily understood, certain terms and phrases are defined below and throughout the specification.

The articles “a” and “an” are used herein to refer to one or to more than one (i.e., to at least one) of the grammatical object of the article. By way of example, “an element” means one element or more than one element.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Numeric ranges are inclusive of the numbers defining the range. Measured and measurable values are understood to be approximate, taking into account significant digits and the error associated with the measurement. As used in this application, the terms “about” and “approximately” have their art-understood meanings; use of one vs. the other does not necessarily imply different scope. Unless otherwise indicated, numerals used in this application, with or without a modifying term such as “about” or “approximately”, should be understood to encompass normal divergence and/or fluctuations as would be appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of a stated reference value unless otherwise stated or otherwise evident from the context (except where such number would exceed 100% of a possible value).

In some embodiments, the present disclosure relates to an adhesive material, comprising a polymer and a filler; wherein the adhesive material has a temperature; and
a) if the temperature of the adhesive material is equal to or below a reference temperature, then the adhesive material adheres to an adherend; and
b) if the temperature of the adhesive material is above the reference temperature, then the adhesive does not adhere to an adherend.

In some embodiments, the present disclosure relates to an adhesive material, comprising a polymer and a filler; wherein the adhesive material has a temperature; and
a) if the temperature of the adhesive material is equal to or above a reference temperature, then the adhesive material adheres to an adherend; and
b) if the temperature of the adhesive material is below the reference temperature, then the adhesive does not adhere to an adherend.

In some embodiments, the polymer is an upper critical solution temperature (UCST) polymer or a lower critical solution temperature (LCST) polymer. Polymers having lower or upper critical solution temperature (LCST or UCST) in solution display a miscibility gap at high temperatures or low temperatures, respectively, and undergo phase separation into a polymer-poor and polymer-rich phase. During phase separation the polymer chains undergo a transition from the open coil state to the globule state. If the globules are not stabilized by surfactants or other means, subsequent aggregation to visible particles causes turbidity. UCST and LCST polymers are described, for example, in U.S. Pat. No. 10,122,054, the entire contents of which are incorporated herein by reference. In some embodiments, the polymer is a UCST polymer. In some embodiments, the polymer is an LCST polymer.

In some embodiments, polymer is selected from the group consisting of poly(sulfobetaine), poly(ethylene oxide), poly(vinyl methyl ether), hydrophobically modified poly(vinyl alcohol), poly(hydroxyethylmethacrylate), poly(acrylic acid), poly(uracilacrylate), poly((meth)acrylamide-co-N-acetylacrylamide), poly(N-acryloylasparagineamide, poly(N-acryloylglutamineamide, and poly(N-methacryloylasparagineamide), poly(N-isopropylacrylamide), poly(N,N-diethylacrylamide), poly(N-vinlycaprolactam), poly [2-(dimethylamino)ethyl methacrylate], poly(ethylene glycol), and poly(ethylene oxide). In some embodiments, the polymer is selected from the group consisting of poly(N-isopropylacrylamide), poly(N-vinylcaprolactam), poly [2-(dimethylamino)ethyl methacrylate], poly [3-(dimethyl (4-vinylbenzyl) ammonium) propyl sulfonate], and poly([2-(methacryloyloxy)ethyl]dimethyl-[3-sulfopropyl]ammonium hydroxide).

In some embodiments, the polymer is UCST polymer selected from the group consisting of poly(sulfobetaine), poly(ethylene oxide), poly(vinyl methyl ether), hydrophobically modified poly(vinyl alcohol), poly(hydroxyethylmethacrylate), poly(acrylic acid), poly(uracilacrylate), poly((meth)acrylamide-co-N-acetylacrylamide), poly(N-acryloylasparagineamide, poly(N-acryloylglutamineamide, and poly(N-methacryloylasparagineamide).

In some embodiments, the polymer is LCST polymer selected from the group consisting of poly(N-isopropylacrylamide), poly(N,N-diethylacrylamide), poly(N-vinlycaprolactam), poly [2-(dimethylamino)ethyl methacrylate], poly(ethylene glycol), and poly(ethylene oxide). In some embodiments, the polymer is poly(N-isopropylacrylamide).

In some embodiments, the filler comprises silica, silicate, metal oxide, carbon nanotube, or polymer. For example, in certain embodiments, the filler comprises a silicate. In some embodiments, the filler is a phyllosilicate. In some embodiments, the filler comprises a nanoclay.

In some embodiments, the nanoclay is a phyllosilicate. In some embodiments, the nanoclay comprises montmorillonite. In some embodiments, the nanoclay comprises magnesium silicate.

In some embodiments, the filler comprises nanoparticles. In some embodiments, the filler comprises nanoclay nanoparticles. In some embodiments, the nanoparticles have an average diameter about 1 nm to about 1 μm. For example, in certain embodiments, the nanoparticles have an average diameter about 10 nm to about 1 μm, about 10 nm to about 1 μm, about 20 nm to about 1 μm, about 50 nm to about 1 μm, about 100 nm to about 1 μm, about 200 nm to about 1 μm, about 300 nm to about 1 μm, about 400 nm to about 1 μm, about 500 nm to about 1 μm, about 700 nm to about 1 μm, about 10 nm to about 700 nm, about 20 nm to about 700 nm, about 50 nm to about 700 nm, about 100 nm to about 700 nm, about 200 nm to about 700 nm, about 300 nm to about 700 nm, about 400 nm to about 700 nm, about 500 nm to about 700 nm, about 10 nm to about 500 nm, about 20 nm to about 500 nm, about 50 nm to about 500 nm, about 100 nm to about 500 nm, about 200 nm to about 500 nm, about 300 nm to about 500 nm, about 10 nm to about 200 nm, about 20 nm to about 200 nm, about 30 nm to about 200 nm, about 40 nm to about 200 nm, about 50 nm to about 200 nm, about 60 nm to about 200 nm, about 70 nm to about 200 nm, about 80 nm to about 200 nm, about 90 nm to about 200 nm, about 100 nm to about 200 nm, about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 1 nm to about 50 nm, about 10 nm to about 50 nm, about 20 nm to about 50 nm, about 1 nm to about 40 nm, about 5 nm to about 40 nm, about 10 nm to about 40 nm, about 20 nm to about 40 nm, about 1 nm to about 20 nm, about 5 nm to about 20 nm, or about 10 nm to about 20 nm. In certain embodiments, the nanoparticles have an average diameter about 10 μm, about 8 μm, about 5 μm, about 2 μm, about 1 μm, about 900 nm, about 800 nm, about 700 nm, about 600 nm, 500 nm, about 400 nm, about 300 nm, about 200 nm, about 100 nm, about 90 nm, about 80 nm, about 70 nm, about 60 nm, about 50 nm, about 40 nm, about 30 nm, about 20 nm, about 10 nm, about 5 nm, or about 1 nm. In some embodiments, the nanoparticles have an average diameter of about 25 nm.

In some embodiments, the adhesive material comprises the filler and the polymer in a mass ratio of about 0.005 to about 1. For example, in certain embodiments, the adhesive material comprises the filler and the polymer in a mass ratio of about 0.01 to about 1, about 0.05 to about 1, about 0.1 to about 1, about 0.2 to about 1, about 0.3 to about 1, about 0.4 to about 1, about 0.5 to about 1, about 0.6 to about 1, about 0.7 to about 1, about 0.8 to about 1, about 0.01 to about 0.7, about 0.05 to about 0.7, about 0.1 to about 0.7, about 0.2 to about 0.7, about 0.3 to about 0.7, about 0.4 to about 0.7, about 0.5 to about 0.7, 0.01 to about 0.5, 0.05 to about 0.5, 0.1 to about 0.5, 0.2 to about 0.5, 0.3 to about 0.5, 0.01 to about 0.3, 0.05 to about 0.3, 0.1 to about 0.3, 0.2 to about 0.3, 0.01 to about 0.1, or 0.05 to about 0.1. For example, in certain embodiments, the adhesive material comprises the filler and the polymer in a mass ratio of about 0.005, about 0.01, about 0.015, about 0.02, about 0.025, about 0.03, about 0.035, about 0.04, about 0.045, about 0.05, about 0.055, about 0.06, about 0.065, about 0.07, about 0.075, about 0.08, about 0.085, about 0.09, about 0.095, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 1. In some embodiments, the adhesive material comprises the filler and the polymer in a mass ratio of about 0.5.

In some embodiments, the reference temperature is about 0° C. to about 100° C. In some embodiments, the reference temperature is about 10° C. to about 100° C. In some embodiments, the reference temperature is about 20° C. to about 100° C., about 30° C. to about 100° C., about 40° C. to about 100° C., about 50° C. to about 100° C., about 60° C. to about 100° C., about 70° C. to about 100° C., about 80° C. to about 100° C., about 20° C. to about 80° C., about 30° C. to about 80° C., about 40° C. to about 80° C., about 50° C. to about 80° C., about 60° C. to about 80° C., about 70° C. to about 80° C., about 20° C. to about 60° C., about 30° C. to about 60° C., about 40° C. to about 60° C., about 50° C. to about 60° C., about 20° C. to about 50° C., about 30° C. to about 50° C., about 40° C. to about 50° C., about 20° C. to about 40° C., about 30° C. to about 40° C., or about 20° C. to about 30° C. For example, in certain embodiments, the reference temperature is about 100° C., about 95° C., about 90° C., about 85° C., about 80° C., about 75° C., about 70° C., about 65° C., about 60° C., about 55° C., about 50° C., about 45° C., about 40° C., about 35° C., about 30° C., about 25° C., about 20° C., about 15° C., or about 10° C. In some embodiments, the reference temperature is about 32° C.

In some embodiments, the adhesive material adheres to an adherend when heated above the reference temperature after the adhesive has been subjected to a cycle of heating above the reference temperature and cooling below the reference temperature about 10 to about 30 times. For example, in certain embodiments, the adhesive material adheres to an adherend when heated above the reference temperature after the adhesive has been subjected to a cycle of heating above the reference temperature and cooling below the reference temperature about 10, about 15, about 20, about 25, or about 30 time. In some embodiments, the adhesive material has been subjected to the cycle of heating above the reference temperature and cooling below the reference temperature about 10 times.

In some embodiments, the adherend is selected from the group consisting of glass, polymer, silicone rubber, metal, and wood. For example, the adherent is glass. For example, the adherent is glass. For example, the adherent is polymer. For example, the adherent is silicone rubber. For example, the adherent is metal. For example, the adherent is wood.

In some embodiments, the adhesive material further comprises about 10% to about 80% water by weight. For example, in certain embodiments, the adhesive material further comprises about 10% to about 70%, about 10% to about 60%, about 10% to about 50%, about 10% to about 40%, about 10% to about 30%, about 10% to about 20%, about 20% to about 70%, about 20% to about 60%, about 20% to about 50%, about 20% to about 40%, about 20% to about 30%, about 30% to about 70%, about 30% to about 60%, about 30% to about 50%, about 30% to about 40%, about 40% to about 70%, about 40% to about 60%, about 40% to about 50%, about 50% to about 70%, about 60% to about 70%, or about 50% to about 60% water by weight. For example, in certain embodiments, the adhesive material further comprises about 10%, 15%, 20%, 25%, 30%, 35%, 40%, 45%, 50%, 55%, 60%, 65%, 70%, 75%, or 80% water by weight.

In some embodiments, the present disclosure relates to a method of making the adhesive material disclosed herein, comprising
a) combining the polymer, the filler, and a solvent, thereby producing a first solution;
b) adding an initiator and an accelerator to the first solution, thereby producing a precursor solution; and
c) casting the precursor solution, thereby producing the adhesive material.

In some embodiments, the solvent is water, the initiator is ammonium persulfate, and the accelerator is N,N,N′,N′-tetramethylethylenediamine.

In some embodiments, the precursor solution comprises:
1) the filler and the polymer in a mass ratio about 0.05 to about 1;
2) the initiator and the polymer in a mass ratio about 1×10⁻³ to about 1×10⁻²; and
3) the accelerator and the polymer in a mass ratio about 1×10⁻³ to about 0.1.

In some embodiments, the precursor solution comprises:
1) the filler and the polymer in a mass ratio about 0.5;
2) the initiator and the polymer in a mass ratio about 4×10⁻³; and
3) the accelerator and the polymer in a mass ratio about 7×10⁻².

### Materials and Methods

### Materials for Adhesives

N-isopropylacrylamide (NIPAm, Tokyo Chemical Industry, I0401), nanoclay (Laponite RD, BYK USA), N,N,N′,N′-tetramethylethylenediamin (TEMED, Sigma-Aldrich, T7024), and ammonium persulfate (APS, Sigma-Aldrich, A3678) were used. All chemicals were used as received without any further purification.

### Materials as Adherends

The following materials were used as adherends: glass (borosilicate glass sheet, McMaster-Carr), PET (polyethylene terephthalate, McMaster-Carr), PE (polyethylene, McMaster-Carr), PP (polypropylene, Amazon), PTFE (polytetrafluoroethylene, Amazon), PMMA (poly(methyl methacrylate), Amazon), silicone rubber (silicone rubber sheet, 50A durometer, Amazon), aluminum (6061 aluminum sheets, McMaster-Carr), copper (110 copper bars, McMaster-Carr), steel (304 stainless steel, McMaster-Carr), and wood (Amazon).

### Preparation of Adhesives

For all the PNIPAm adhesives synthesized in this paper, the amount of NIPAm was fixed (monomers), and the amounts of other chemicals including the nanoclay (crosslinker), APS (initiator), and TEMED (accelerator) were varied. 6.3 g NIPAm and a certain amount of nanoclay were dissolved into 30 mL deionized water. The mixture was stirred overnight in a sealed container to form a homogeneous and transparent solution. APS and TEMED were added to the solution which was mixed by a speed mixer (FleckTeck DAC 330) at 2000 rpm for 2 minutes. The precursor solution was then poured into a glass mold and covered with a glass plate for curing at room temperature overnight to complete the polymerization. To reduce the effect of oxygen on the polymerization, the glass mold was sealed with a plastic film and enclosed in a sealed sample bag.

The various mass ratios of nanoclay, APS, and TEMED were:
M_{Clay}/M_{NIPAm}=0.079, 0.158, 0.238, 0.317 and 0.476;
M_{APS}/M_{NIPAm}=1.909×10⁻³, 2.863×10⁻³, 3.818×10⁻³, 5.727×10⁻³, and 7.635×10⁻³; and
M_{TEMED}/M_{NIPAm}=7.251×10⁻³ and 72.51×10⁻³.

To investigate the effect of water content on adhesion, identical PNIPAm gels with 6.3 g NIPAm, 30 mL deionized water, M_{Clay}/M_{NIPAm}=0.238, M_{APS}/M_{NIPAm}=2.863×10⁻³, and M_{TEMED}/M_{NIPAm}=7.251×10⁻³ were synthesized. This corresponds to a water content of M_{water}/M_{gel}=0.7936. After the synthesis, solvent exchange was used to obtain gels with various water contents. For M_{water}/M_{gel}=0.912 or 0.930, a gel was swollen in the deionized water. For M_{water}/M_{gel}=0.310, 0.481, or 0.654, a gel was dried in the fume hood. In each case, the swelling or drying was continued until the gel reached the desired water content measured by its weight. Afterwards, the gel was stored in a sealed sample bag for 48 hours to reach thermodynamic equilibrium. The weights of all gels were measured again before their final characterization.

After exploring the synthesis-property relationship in FIG. 2, the final composition of the PNIPAm adhesive was fixed with M_{Clay}/M_{NIPAm}=0.476, M_{APS}/M_{NIPAm}=2.863×10⁻³, and M_{TEMED}/M_{NIPAm}=72.51×10⁻³, and M_{water}/M_{gel}=0.7936.

For example, in one sample synthesis 6.3 g NIPAm were dissolved in 30 g DI water with M_{water}/M_{NIPAm}=4.76, M_{Clay}/M_{NIPAm}=0.476, M_{APS}/M_{NIPAm}=3.818×10⁻³, and M_{TEMED}/M_{NIPAm}=72.518×10⁻³. To study the effect of clay on adhesion, M_{Clay}/M_{NIPAm} values of 0.079, 0.158, 0.238, 0.317 and 0.476 were used. The precursors of adhesives were poured into two glass molds with 1 mm of silicone rubber in the middle. For investigation of water effect on adhesion, M_{clay}/M_{NIPAm}=0.238 were used to synthesize the pristine samples. To get higher water content, pristine adhesives were swollen in water. For lower water content, the adhesives were dried in fume hood.

### Preparation of Reused Adhesives

After a probe-pull experiment (FIG. 21), all the broken adhesive pieces were collected and patched together. The patched adhesive was reshaped by a glass mold, compressed with a heavy weight, and allowed to heal for 24 hours. The adhesion strength was measured again after the healing.

### Preparation of Stored Adhesives

To get stored adhesives, fresh adhesives were dried in fume hood for 6 hours. Then, dried adhesives were broken into small particles by hand and stored in bags for 10 days. 9.3 g of dry adhesive particles were mixed into 30 mL of water to swell until equilibrium. The swollen adhesive pieces were subsequently patched together, transferred into a glass mold, compressed with a heavy weight, and allowed to heal for 24 hours.

### Adhesion Test

Adhesives were cut into circular shapes with diameter of 2 cm by laser cutter on PMMA sheets. After that, adhesives were adhered with substrates via the exposed sticky side, and then were pressed on PMMA sides with weights for 5 minutes. To test adhesives, substrates were fixed at the bottom of Instron, and PMMA sides of adhesives were adhered to Instron (Instron 34TM-5) joint via VHB. Before testing, we connected the joint with Instron. When testing, the adhesives were pulled out with speed of 0.1 mm/s. To test the adhesive conveniently, the adhesives were tested by adhering PMMA sides of adhesives to the bottom of a lab-made device and hanging the top of the device to Instron. The data measured by both ways were consistent (87.19 kPa by Lab-made device and 88.30 kPa by Instron Joint).

### Characterization of Adhesion Strength.

The adhesion strength was characterized by the probe-pull experiment. The PNIPAm adhesive of circular shape with a diameter of 2 cm and thickness of 1 mm thickness was fixed to a circular acrylic sheet on one side by super glue (Loctite), and attached to an adherend on the other side. The sandwiched structure was compressed by a 3 kg weight (about 95 kPa compressive stress) for 5 minutes to form the adhesion. Afterwards, the structure was mounted into an Instron tensile tester (34TM-5), with its top acrylic sheet fixed to a gripper and the bottom adherend to another gripper via the adhesive tape VHB (4905, 3M) (FIG. 7(a)). The Instron conducted a tensile test with a fixed speed of 0.1 mm/s to measure force-displacement curve (FIG. 7(b)). The adhesion strength was calculated as the peak force divided by the initial cross-sectional area of the adhesive. The adhesion strengths measured with or without the gripper were nearly identical, as confirmed by control experiments.

### Characterization of Adhesion Energy

A bilayer of PNIPAm adhesive and adherend was formed by direct attachment with the same prescribed compressive force as in the characterization of adhesion strength. The other side of the PNIPAm adhesive was attached by a stiff backing layer made of PET via super glue (Loctite), to constrain the elastic deformation of the adhesive during peeling. The entire composite formed a strip of 5 cm in length and 1 cm in width, with a 0.5 cm interfacial pre-crack between the adhesive and adherend at its one end. The strip was subsequently mounted into the Instron tester (34TM-5) and subjected to a double-peeling test (for flexible adherends including PET, PP, PTFE, and silicone rubber, as illustrated in FIG. 8(a)) or a 90-degree peeling test (for stiff adherends including PE, PMMA, aluminum, copper, steel, and wood). In either test, the crack speed was prescribed as 1 mm/s, directly controlled by the peeling speed. The raw data of a measured force-displacement curve is shown in FIG. 8(b). The curve reached a steady state with a plateau when the peeling displacement increases. The adhesion energy was calculated as Γ=2F/w in double peeling, and Γ=F/w for 90-degree peeling (26), where F is the measured steady-state force and w=1 cm is the sample width.

### Thermal Imaging

For the thermal imaging in FIG. 14, a thermal camera (HIKMICRO Thermal Imaging Camera Pocket2, 256×192 IR resolution) was used to show the temperature distribution.

Adhesive Gripper with Programmed Heating

An adhesive gripper was assembled by laser-cut acrylic parts as shown in FIG. 17. The gripper was further integrated with a ceramic heater (HT19R Thorlabs) and in situ temperature sensor on it (TH100PT Thorlabs). The heater was programmed by a temperature controller (THORLABS TC 200). The PNIPAm adhesive was attached to the bottom of the heater. During a programmed heating, a prescribed temperature was set on the controller and the switch was turned on. When the heating switch was turned off on the controller, the adhesive naturally cooled down to room temperature and became sticky again.

### Characterization of Switching Time

The top of the adhesive gripper was connected to the Instron gripper while the PNIPAm adhesive at the bottom was attached to a steel dead weight of 250 g with a diameter 1.7 cm, resulting in a measured stress of about 11 kPa by Instron (FIGS. 7(c) and 18). In an experiment with thermo-induced switching, the heater was set to a target temperature of 40° C., and the gripper held the dead weight for about 14 s, followed by the drop of the dead weight and thus the measured stress (FIGS. 18(d) and 7(d)). In another control experiment, the heater was turned off, and the gripper held the weight for more than 100 s at room temperature (FIG. 18(a)).

### Characterization of Cyclic Switching

The cyclic switching of adhesion was characterized following the experimental setup in FIG. 15. The top of the adhesive gripper was connected to the Instron gripper while the PNIPAm adhesive at the bottom was attached to an adherend. The adherend was affixed to a hot plate, and the hot plate was affixed to the bottom of the Instron tensile tester. In one switching cycle, the PNIPAm adhesive was first brought into contact with the adherend with a gentle compression at room temperature to form the adhesion. The adherend was subsequently heated to 75° C. set by the hot plate. When the adhesive became completely opaque due to the thermo-induced phase transition, it was detached from the adherend. A subsequent switching cycle was started after approximately 1 minute to ensure all materials were completely cooled back to room temperature. To measure the adhesion strength and switching performance after a specified number of switching cycles, multiple identical samples were prepared and their adhesion strength at room temperature and at high temperature was measured after 1, 3, 5, 7, and 10 switching cycles. A total of 30 samples were measured (for each specific cycle number, 3 samples at room temperature and 3 samples at high temperature were measured). For more switching cycles (i.e., 30 cycles shown in FIG. 16), a slight amount of deionized water was sprayed on the surface of the adhesive after each cycle to keep the adhesive from drying due to the continuous heating.

### Characterization of Contact Angle

Contact angles of various adherends were measured by a Phoenix 150 contact angle measurement system. In each measurement, deionized water was dripped onto an adherend substrate three times to obtain one data point (FIG. 20).

TABLE 1
Adhesion strength at room and high temperatures
after 1 and 10 switching cycles.

| | Adhesion Strength (kPa) | | | |
|---|---|---|---|---|
| | | Switched 1 | | Switched 10 |
| Adherend | 1 cycle | cycle | 10 cycles | cycle |
| Glass | 87.19 ± 4.27 | 0.58 ± 0.16 | 88.72 ± 5.16 | 1.89 ± 0.32 |
| PET | 86.92 ± 3.32 | 1.22 ± 0.18 | 115.77 ± 30.13 | 0.82 ± 0.43 |
| PE | 84.49 ± 6.39 | 0.36 ± 0.08 | 91.57 ± 7.50 | 0.75 ± 0.31 |
| PP | 76.57 ± 3.17 | 1.01 ± 0.60 | 62.55 ± 5.09 | 0.34 ± 0.05 |
| PTFE | 67.24 ± 1.35 | 0.74 ± 0.54 | 60.74 ± 5.10 | 0.75 ± 0.19 |
| PMMA | 85.96 ± 2.82 | 1.33 ± 0.43 | 89.51 ± 12.74 | 0.77 ± 0.37 |
| Silicone | 79.52 ± 5.15 | 1.130 ± 0.65 | 49.00 ± 15.17 | 0.85 ± 0.24 |
| Rubber | | | | |
| Aluminum | 82.39 ± 8.50 | 0.91 ± 0.40 | 98.49 ± 3.96 | 0.39 ± 0.27 |
| Copper | 79.27 ± 2.87 | 0.73 ± 0.28 | 78.15 ± 9.52 | 0.66 ± 0.37 |
| Steel | 88.68 ± 9.97 | 0.53 ± 0.33 | 89.11 ± 18.36 | 0.26 ± 0.08 |
| Wood | 39.34 ± 5.22 | 2.82 ± 0.77 | 29.15 ± 5.23 | 0.36 ± 0.04 |

TABLE 2
Contact angle, adhesion strength, and
adhesion energy of various adherends.

| | Contact Angle | Adhesion Strength | Adhesion Energy |
|---|---|---|---|
| Adherend | (°) | (kPa) | (J/m²) |
| Glass | 52.95 ± 3.71 | 87.19 ± 4.27 | 26.18 ± 16.25 |
| Aluminum | 59.92 ± 6.61 | 82.39 ± 8.50 | 71.64 ± 16.87 |
| PMMA | 69.17 ± 4.85 | 85.96 ± 2.82 | 10.23 ± 3.35 |
| PET | 69.98 ± 1.77 | 86.92 ± 3.32 | 606.68 ± 375.90 |
| Copper | 72.19 ± 3.30 | 79.27 ± 2.87 | 3.00 ± 1.66 |
| Steel | 76.41 ± 3.56 | 88.68 ± 9.97 | 29.40 ± 3.94 |
| Silicone | 99.22 ± 2.74 | 79.52 ± 5.14 | 123.40 ± 19.26 |
| Rubber | | | |
| PP | 103.87 ± 1.18 | 76.57 ± 3.17 | 7.04 ± 4.72 |
| PTFE | 117.55 ± 1.76 | 67.24 1.35 | 601.19 ± 119.04 |
| PE | 126.24 ± 0.21 | 84.49 ± 6.39 | 16.14 ± 11.25 |

TABLE 3
Weight, geometry, and switching time of various objects.

| | Weight | Diameter | Length | Switching Time |
|---|---|---|---|---|
| Object | (g) | (mm) | (cm) | (s) |
| Tomato | 8.7 | 20 | 2.9 | 4 |
| Lotus Seed | 1.066 | 10 | 1.1 | 3 |
| Wood Rod | 0.25 | 5 | 1.9 | 11 |
| Plastic Screw | 0.35 | 6 | 3.8 | 5 |
| Copper Screw | 1.89 | 4 | 2.6 | 10 |
| Steel Nail | 0.32 | 1 | 2.5 | 9 |
| Plastic Bead | 0.37 | 6 | 0.6 | 15 |
| Coin Battery | 1.925 | 10 | 1 | 12 |

### REFERENCES

1. E. Arzt, S. Gorb and R. Spolenak, Proc. Natl. Acad. Sci. USA, 2003, 100, 10603-10606.
2. S. D. De Rivaz, B. Goldberg, N. Doshi, K. Jayaram, J. Zhou and R. J. Wood, Science Robotics, 2018, 3, eaau3038.
3. Y. Chen, H. Zhao, J. Mao, P. Chirarattananon, E. F. Helbling, N.-s. P. Hyun, D. R. Clarke and R. J. Wood, Nature, 2019, 575, 324-329.
4. N. Gershenfeld, M. Carney, B. Jenett, S. Calisch and S. Wilson, Architectural Design, 2015, 85, 122-127.
5. J. Mici, J. W. Ko, J. West, J. Jaquith and H. Lipson, Additive Manufacturing, 2019, 27, 451-460.
6. M. Chen, Y. Wu, B. Chen, A. M. Tucker, A. Jagota and S. Yang, Proceedings of the National Academy of Sciences, 2022, 119, e2203074119.
7. S. O. Blacklow, J. Li, B. R. Freedman, M. Zeidi, C. Chen and D. J. Mooney, Science Advances, 2019, 5, eaaw3963.
8. H. Yuk, J. Wu and X. Zhao, Nat. Rev. Mater., 2022, 7, 935-952.
9. H. Yuk, B. Lu and X. Zhao, Chemical Society Reviews, 2019, 48, 1642-1667.
10. Z. Liu and F. Yan, Advanced Science, 2022, 9, 2200264.
11. S. T. Frey, A. T. Haque, R. Tutika, E. V. Krotz, C. Lee, C. B. Haverkamp, E. J. Markvicka and M. D. Bartlett, Science Advances, 2022, 8, eabq1905.
12. A. Koivikko, D.-M. Drotlef, M. Sitti and V. Sariola, Extreme Mechanics Letters, 2021, 44, 101263.
13. J. Shintake, S. Rosset, B. Schubert, D. Floreano and H. Shea, Advanced Materials, 2016, 28, 231-238.
14. R. Coulson, C. J. Stabile, K. T. Turner and C. Majidi, Soft Robot, 2022, 9, 189-200.
15. M. Tatari, A. Mohammadi Nasab, K. T. Turner and W. Shan, Advanced Materials Interfaces, 2018, 5, 1800321.
16. S. Reddy, E. Arzt and A. del Campo, Advanced Materials, 2007, 19, 3833-3837.
17. D. M. Drotlef, P. Blumler and A. Del Campo, Advanced Materials, 2014, 26, 775-779.
18. A. B. Croll, N. Hosseini and M. D. Bartlett, Advanced Materials Technologies, 2019, 4, 1900193.
19. N. D. Blelloch, H. J. Yarbrough and K. A. Mirica, Chem. Sci., 2021, 12, 15183-15205.
20. C. Bandl, W. Kern and S. Schlögl, International Journal of Adhesion and Adhesives, 2020, 99, 102585.
21. C. Creton, MRS Bull., 2003, 28, 434-439.
22. C. Creton and M. Ciccotti, Reports on Progress in Physics, 2016, 79, 046601.
23. D. Satas, Handbook of pressure sensitive adhesive technology, Van Nostrand Reinhold New York, 1989.
24. A. Sierra-Romero, K. Novakovic and M. Geoghegan, Langmuir, 2022, 38, 15476-15493.
25. A. Hutchinson, Y. Liu and Y. Lu, The Journal of Adhesion, 2017, 93, 737-755.
26. R. Puligadda, S. Pillalamarri, W. Hong, C. Brubaker, M. Wimplinger and S. Pargfrieder, MRS Proceedings, 2006, 970, 0970-Y0904-0909.
27. E. Sato, H. Tamura and A. Matsumoto, ACS Appl. Mater. Inter., 2010, 2, 2594-2601.
28. E. Sato, T. Hagihara and A. Matsumoto, ACS Appl. Mater. Inter., 2012, 4, 2057-2064.
29. T. Ozawa, S. Ishiwata, Y. Kano and T. Kasemura, The Journal of Adhesion, 2006, 72, 1-16.
30. J. Chen, Y. Cui, Z. Ding, H. Jiang, Z. He, L. Song and B. Liu, Progress in Organic Coatings, 2023, 184.
31. H. Zhou, C. Xue, P. Weis, Y. Suzuki, S. Huang, K. Koynov, G. K. Auernhammer, R. Berger, H.-J. Butt and S. Wu, Nat. Chem., 2017, 9, 145-151.
32. T.-H. Lee, G.-Y. Han, M.-B. Yi, H.-J. Kim, J.-H. Lee and S. Kim, ACS Appl. Mater. Inter., 2021, 13, 43364-43373.
33. T.-H. Lee, J.-H. Back, J.-S. Lim, G.-Y. Han, M.-B. Yi, Y. Kim, J.-H. Lee, S. Kim and H.-J. Kim, Composites Part B: Engineering, 2024, 272, 111175.
34. D. K. Hohl and C. Weder, Adv. Opt. Mater., 2019, 7, 1900230.
35. M. A. Meitl, Z.-T. Zhu, V. Kumar, K. J. Lee, X. Feng, Y. Y. Huang, I. Adesida, R. G. Nuzzo and J. A. Rogers, Nature Materials, 2005, 5, 33-38.
36. S. Kim, J. Wu, A. Carlson, S. H. Jin, A. Kovalsky, P. Glass, Z. Liu, N. Ahmed, S. L. Elgan, W. Chen, P. M. Ferreira, M. Sitti, Y. Huang and J. A. Rogers, Proc. Natl. Acad. Sci. USA, 2010, 107, 17095-17100.
37. J. D. Eisenhaure, T. Xie, S. Varghese and S. Kim, ACS Appl Mater Interfaces, 2013, 5, 7714-7717.
38. C. Linghu, X. Yang, Y. Liu, D. Li, H. Gao and K. J. Hsia, J. Mech. Phys. Solids, 2023, 170, 105091.
39. C. Linghu, Y. Liu, Y. Y. Tan, J. H. M. Sing, Y. Tang, A. Zhou, X. Wang, D. Li, H. Gao and K. J. Hsia, Proc. Natl. Acad. Sci. USA, 2023, 120, e2221049120.
40. X. Chen, H. Yuk, J. Wu, C. S. Nabzdyk and X. Zhao, Proc. Natl. Acad. Sci. USA, 2020, 117, 15497-15503.
41. Z. Zhang, C. Qin, H. Feng, Y. Xiang, B. Yu, X. Pei, Y. Ma and F. Zhou, Nature Communications, 2022, 13, 6964.
42. Z. Shao and Q. Liu, Extreme Mech. Lett., 2023, 61, 101996.
43. H. Cho, G. Wu, J. Christopher Jolly, N. Fortoul, Z. He, Y. Gao, A. Jagota and S. Yang, Proceedings of the National Academy of Sciences, 2019, 116, 13774-13779.
44. J. Yang, R. Bai, B. Chen and Z. Suo, Advanced Functional Materials, 2020, 30, 1901693.
45. J. Tang, Q. Yin, M. Shi, M. Yang, H. Yang, B. Sun, B. Guo and T. Wang, Extreme Mechanics Letters, 2021, 46, 101305.
46. Y. Jin, C. Liu, W. Chai, A. Compaan and Y. Huang, ACS Applied Materials & Interfaces, 2017, 9, 17456-17465.
47. J. Tang, Q. Yin, Y. Qiao and T. Wang, ACS applied materials & interfaces, 2019, 11, 21194-21200.
48. Z. J. Wang, C. Y. Li, X. Y. Zhao, Z. L. Wu and Q. Zheng, Journal of materials chemistry B, 2019, 7, 1674-1678.
49. S. Cai and Z. Suo, J. Mech. Phys. Solids, 2011, 59, 2259-2278.
50. X. Qian, Y. Zhao, Y. Alsaid, X. Wang, M. Hua, T. Galy, H. Gopalakrishna, Y. Yang, J. Cui, N. Liu, M. Marszewski, L. Pilon, H. Jiang and X. He, Nat, Nanotechnol., 2019, 14, 1048-1055.
51. J. Kim, G. Zhang, M. Shi and Z. Suo, Science, 2021, 374, 212-216.
52. R. Bai, J. Yang and Z. Suo, European Journal of Mechanics-A/Solids, 2019, 74, 337-370.
53. G. Lake and A. Thomas, Proceedings of the Royal Society of London. Series A. Mathematical and Physical Sciences, 1967, 300, 108-119.
54. J. Y. Sun, X. Zhao, W. R. Illeperuma, O. Chaudhuri, K. H. Oh, D. J. Mooney, J. J. Vlassak and Z. Suo, Nature, 2012, 489, 133-136.
55. J. Li, W. R. Illeperuma, Z. Suo and J. J. Vlassak, ACS Macro Letters, 2014, 3, 520-523.
56. Z. Zhou, J. Lei and Z. Liu, Polymer, 2022, 246.
57. M. Heskins and J. E. Guillet, Journal of Macromolecular Science-Chemistry, 1968, 2, 1441-1455.
58. J. Tang, J. Li, J. J. Vlassak and Z. Suo, Soft Matter, 2016, 12, 1093-1099.
59. J. Yang, R. Bai and Z. Suo, Adv. Mater., 2018, 30, 1800671.
60. K. Haraguchi and T. Takehisa, Advanced materials, 2002, 14, 1120-1124.
61. P.-G. de Gennes, Langmuir, 1996, 12, 4497-4500.
62. A. Gent, Langmuir, 1996, 12, 4492-4496.
63. A. Gent and J. Schultz, The Journal of Adhesion, 1972, 3, 281-294.
64. Z. Yang, X. Yang, R. Long and J. Li, Langmuir, 2021, 37, 7097-7106.
65. S. Y. Zheng, Y. Shen, F. Zhu, J. Yin, J. Qian, J. Fu, Z. L. Wu and Q. Zheng, Advanced Functional Materials, 2018, 28, 1803366.
66. M. Hua, D. Wu, S. Wu, Y. Ma, Y. Alsaid and X. He, ACS Applied Materials & Interfaces, 2021, 13, 12689-12697.
67. M. T. Cook, P. Haddow, S. B. Kirton and W. J. McAuley, Advanced Functional Materials, 2021, 31, 2008123.
68. J. Seuring and S. Agarwal, Macromolecular Rapid Communications, 2012, 33, 1898-1920.
69. J. Hwang, D. Lim, G. Lee, Y. E. Kim, J. Park, M.-J. Baek, H.-S. Kim, K. Park, K. H. Ku and D. W. Lee, Materials Horizons, 2023, 10, 2013-2023.
70. A. Synytska, E. Svetushkina, N. Puretskiy, G. Stoychev, S. Berger, L. Ionov, C. Bellmann, K.-J. Eichhorn and M. Stamm, Soft Matter, 2010, 6, 5907-5914.
71. I. B. Malham and L. Bureau, Langmuir, 2010, 26, 4762-4768.
72. Y. Zhao, Y. Wu, L. Wang, M. Zhang, X. Chen, M. Liu, J. Fan, J. Liu, F. Zhou and Z. Wang, Nature communications, 2017, 8, 2218.
73. A. Eklund, O. Ikkala and H. Zhang, Advanced Functional Materials, 2023, 2214091.
74. M. Dompé, F. J. Cedano-Serrano, O. Heckert, N. van den Heuvel, J. van Der Gucht, Y. Tran, D. Hourdet, C. Creton and M. Kamperman, Advanced Materials, 2019, 31, 1808179.
75. K. Jain, R. Vedarajan, M. Watanabe, M. Ishikiriyama and N. Matsumi, Polymer Chemistry, 2015, 6, 6819-6825.

### INCORPORATION BY REFERENCE

All of the U.S. patents and U.S. patent application publications cited herein are hereby incorporated by reference. In case of conflict, the present specification, including definitions, will control.

### EQUIVALENTS

Those skilled in the art will recognize, or be able to ascertain using no more than routine experimentation, many equivalents to the specific embodiments of the invention described herein. Such equivalents are intended to be encompassed by the following claims.

What is claimed is:

1. An adhesive material, comprising a polymer and a filler; wherein the adhesive material has a temperature; and
a) if the temperature of the adhesive material is equal to or below a reference temperature, then the adhesive material adheres to an adherend; and
b) if the temperature of the adhesive material is above the reference temperature, then the adhesive does not adhere to an adherend.

2. The adhesive material of claim 1, wherein the polymer is an upper critical solution temperature (UCST) polymer or a lower critical solution temperature (LCST) polymer.

3. The adhesive material of claim 1, wherein polymer is selected from the group consisting of poly(sulfobetaine), poly(ethylene oxide), poly(vinyl methyl ether), hydrophobically modified poly(vinyl alcohol), poly(hydroxyethylmethacrylate), poly(acrylic acid), poly(uracilacrylate), poly((meth)acrylamide-co-N-acetylacrylamide), poly(N-acryloylasparagineamide, poly(N-acryloylglutamineamide, and poly(N-methacryloylasparagineamide), poly(N-isopropylacrylamide), poly(N,N-diethylacrylamide), poly(N-vinlycaprolactam), poly [2-(dimethylamino)ethyl methacrylate], poly(ethylene glycol), and poly(ethylene oxide).

4. The adhesive material of claim 1, wherein the polymer is selected from the group consisting of poly(N-isopropylacrylamide), poly(N-vinylcaprolactam), poly [2-(dimethylamino)ethyl methacrylate], poly [3-(dimethyl (4-vinylbenzyl)ammonium)propyl sulfonate], and poly([2-(methacryloyloxy)ethyl]dimethyl-[3-sulfopropyl]ammonium hydroxide).

5. The adhesive material of claim 1, wherein the polymer is poly(N-isopropylacrylamide).

6. The adhesive material of claim 1, wherein the filler comprises silica, silicate, metal oxide, carbon nanotube, or polymer.

7. The adhesive material of claim 1, wherein the filler comprises a nanoclay.

8. The adhesive material of claim 7, wherein the nanoclay is a phyllosilicate.

9. The adhesive material of claim 1, wherein the adhesive material comprises the filler and the polymer in a mass ratio of about 0.005 to about 1.

10. The adhesive material of claim 1, wherein the adhesive material comprises the filler and the polymer in a mass ratio of about 0.5.

11. The adhesive material of claim 1, wherein the reference temperature is about 10° C. to about 100° C.

12. The adhesive material of claim 1, wherein the reference temperature is about 32° C.

13. The adhesive material of claim 1, wherein the adhesive material adheres to an adherend when heated above the reference temperature after the adhesive has been subjected to a cycle of heating above the reference temperature and cooling below the reference temperature about 10 to about 30 times.

14. The adhesive material of claim 13, wherein the adhesive material has been subjected to the cycle of heating above the reference temperature and cooling below the reference temperature about 10 times.

15. The adhesive material of claim 1, wherein the adherend is selected from the group consisting of glass, polymer, silicone rubber, metal, and wood.

16. The adhesive material of claim 1, wherein the adhesive material further comprises about 10% to about 80% water by weight.

17. A method of making the adhesive material of claim 1, comprising
a) combining the polymer, the filler, and a solvent, thereby producing a first solution;
b) adding an initiator and an accelerator to the first solution, thereby producing a precursor solution; and
c) casting the precursor solution, thereby producing the adhesive material.

18. The method of claim 17, wherein the solvent is water, the initiator is ammonium persulfate, and the accelerator is N,N,N′,N′-tetramethylethylenediamine.

19. The method of claim 17, wherein the precursor solution comprises:
1) the filler and the polymer in a mass ratio about 0.05 to about 1;
2) the initiator and the polymer in a mass ratio about 1×10⁻³ to about 1×10⁻²; and
3) the accelerator and the polymer in a mass ratio about 1×10⁻³ to about 0.1.

20. The method of claim 17, wherein the precursor solution comprises:
1) the filler and the polymer in a mass ratio about 0.5;
2) the initiator and the polymer in a mass ratio about 4×10⁻³; and
3) the accelerator and the polymer in a mass ratio about 7×10⁻².
